(19) United States
(12) Patent Application Publication
(10) Pub. No.: US 2025/0358033 A1
(43) Pub. Date: Nov. 20, 2025

(54) Accelerated time synchronization follower

(71) Applicant: Mellanox Technologies, Ltd., Yokneam (IL)

(72) Inventors: Natan Manevich, Nesher (IL); Dotan David Levi, Kiryat Motzkin (IL); Nir Laufer, Zoran (IL); Wojciech Wasko, Mlynek (PL); Maciej Machnikowski, Reda (PL); Bar Shapira, Tel Aviv (IL)

(21) Appl. No.: 18/664,340

(22) Filed: May 15, 2024

(51) Int. Cl. H04J 3/06; H04L 7/02

(52) U.S. Cl. CPC H04J 3/0667; H04L 7/02

(57) ABSTRACT

In one embodiment, a system includes a hardware clock to maintain a clock time, and a network device including a network interface to receive a first time-synchronization message from a clock synchronization leader as part of a two-way time synchronization protocol, and a hardware accelerator to identify the first time-synchronization message, cause generation and sending of a second time-synchronization message to the clock synchronization leader in response to identifying the first time synchronization message, and provide timing information associated with the first time-synchronization message and the second time-synchronization message to time-synchronization software running on a host device to synchronize the hardware clock to the clock synchronization leader.

### FIELD OF THE DISCLOSURE

The present disclosure relates to computer systems, in particular, but not exclusively to, clock synchronization.

### BACKGROUND

Clock synchronization among network devices is used in many network applications. One application of using a synchronized clock value is for measuring one-way latency from one device to another device. If the clocks are not synchronized the resulting one-way latency measurement will be inaccurate.

Synchronization is typically achieved by syntonization, in which the clock frequency of two devices is aligned, and aligning the phase between the two devices.

For Ethernet, there are two complementary methods to achieve synchronization. One is Synchronous Ethernet (SyncE), which is a physical-layer protocol which achieves syntonization based on the receive/transmit symbol rate. SyncE is an International Telecommunication Union Telecommunication (ITU-T) Standardization Sector standard for computer networking that facilitates the transference of clock signals over the Ethernet physical layer. In particular, SyncE enables clock syntonization inside a network with respect to a master clock.

The other is Precision Time Protocol (PTP), which is a packet-based protocol that may be used with SyncE to align offset (e.g., in Coordinated Universal Time (UTC) format) and phase between two clocks. PTP is used to accurately synchronize clocks throughout a computer network, and is considered to be the de facto standard for this purpose. PTP is an example of a two-way time synchronization protocol. A two-way time synchronization protocol uses time synchronization packets which are exchanged in both directions between a clock leader and a clock follower.

### SUMMARY

There is provided in accordance with an embodiment of the present disclosure, a system, including a hardware clock to maintain a clock time, and a network device including a network interface to receive a first time-synchronization message from a clock synchronization leader as part of a two-way time synchronization protocol, and a hardware accelerator to identify the first time-synchronization message, cause generation and sending of a second time-synchronization message to the clock synchronization leader in response to identifying the first time synchronization message, and provide timing information associated with the first time-synchronization message and the second time-synchronization message to time-synchronization software running on a host device to synchronize the hardware clock to the clock synchronization leader.

Further in accordance with an embodiment of the present disclosure, the system includes a host device to execute the time-synchronization software to receive the timing information, and synchronize the hardware clock to the clock synchronization leader based on the timing information.

Still further in accordance with an embodiment of the present disclosure the timing information is indicative of a transmission and receive time of the first time-synchronization message and a transmission and receive time of the second time-synchronization message.

Additionally in accordance with an embodiment of the present disclosure the time-synchronization software is to receive the timing information in response to any one or more of the following receiving an interrupt from the network device, polling the network device, a completion queue entry, and detecting writing of the timing information in at least one memory location.

Moreover, in accordance with an embodiment of the present disclosure the network device includes a data processing unit (DPU) including one or more microprocessors, the DPU is to act as the host device to execute the time-synchronization software to receive the timing information, and synchronize the hardware clock to the clock synchronization leader based on the timing information.

Further in accordance with an embodiment of the present disclosure the hardware accelerator includes packet processing circuitry to identify the first time-synchronization message, cause generation and sending of the second time-synchronization message to the clock synchronization leader in response to identifying the first time-synchronization message, and provide timing information associated with the first time-synchronization message and the second time-synchronization message to the time-synchronization software running on the host device to synchronize the hardware clock to the clock synchronization leader.

Still further in accordance with an embodiment of the present disclosure the packet processing circuitry includes steering circuitry to identify the first time-synchronization message and cause generation and sending of the second time-synchronization message based on matching data from the first time-synchronization message with match-and-action tables.

Additionally in accordance with an embodiment of the present disclosure the steering circuitry is to generate the second time-synchronization packet.

Moreover, in accordance with an embodiment of the present disclosure the network device includes a data processing unit (DPU) including one or more microprocessors, the DPU is to generate the second time-synchronization packet.

Further in accordance with an embodiment of the present disclosure the packet processing circuitry is to sample a receive time of the first time-synchronization message and a transmission time of the second time-synchronization message, and provide the sampled receive time and the sampled transmission time or a difference between the sampled transmission time and the sampled received time or another time value based on the sampled receive time and the sampled transmission time to the time-synchronization software running on the host device.

Still further in accordance with an embodiment of the present disclosure the network interface is to receive a third time-synchronization message including the transmission time of the first time-synchronization message, and the network interface is to receive a fourth time-synchronization message including the receive time of the second time-synchronization message.

Additionally in accordance with an embodiment of the present disclosure the packet processing circuitry is to extract the transmission time of the first time-synchronization message and the receive time of the second time-synchronization message from the third time synchronization message and the fourth time-synchronization message, respectively, and provide the extracted transmission time and the extracted receive time or a difference between the extracted transmission time and the extracted receive time or another time value based on the extracted transmission time and the extracted receive time to the time-synchronization software running on the host device.

Moreover in accordance with an embodiment of the present disclosure the packet processing circuitry is configured to provide the third time-synchronization message and the fourth time-synchronization message to the time-synchronization software running on the host device to synchronize the hardware clock to the clock synchronization leader based on the transmission time of the first time-synchronization message and the receive time of the second time-synchronization message included in the third time synchronization message and the fourth time-synchronization message, respectively.

Further in accordance with an embodiment of the present disclosure a difference between (a) a receive time of the first time-synchronization message, and (b) a transmission time of the second time-synchronization message, is a predefined fixed time-difference predefined by a configuration of the hardware accelerator.

Still further in accordance with an embodiment of the present disclosure the two-way time synchronization protocol is Precision Time Protocol (PTP), the first-time synchronization message is a sync message, and the second-time synchronization message is a delay request message.

There is also provided in accordance with another embodiment of the present disclosure, a method, including maintaining a clock time, receiving a first time-synchronization message from a clock synchronization leader as part of a two-way time synchronization protocol, identifying by a hardware accelerator the first time-synchronization message, causing by the hardware accelerator generation and sending of a second time-synchronization message to the clock synchronization leader in response to identifying the first time-synchronization message, and providing by the hardware accelerator timing information associated with the first time-synchronization message and the second time-synchronization message to time-synchronization software running on a host device to synchronize a hardware clock to the clock synchronization leader.

Additionally in accordance with an embodiment of the present disclosure, the method includes receiving by the software the timing information, and synchronizing by the software the hardware clock to the clock synchronization leader based on the timing information.

Moreover, in accordance with an embodiment of the present disclosure the timing information is indicative of a transmission and receive time of the first time-synchronization message and a transmission and receive time of the second time-synchronization message.

Further in accordance with an embodiment of the present disclosure a difference between (a) a receive time of the first time-synchronization message, and (b) a transmission time of the second time-synchronization message, is a predefined fixed time-difference predefined by a configuration of the hardware accelerator.

Still further in accordance with an embodiment of the present disclosure the two-way time synchronization protocol is Precision Time Protocol (PTP), the first-time synchronization message is a sync message, and the second-time synchronization message is a delay request message.

### BRIEF DESCRIPTION OF THE DRAWINGS

The present disclosure will be understood from the following detailed description, taken in conjunction with the drawings in which:

FIG. 1 is a block diagram view of a clock synchronization system constructed and operative in accordance with an embodiment of the present disclosure;

FIG. 2 is a flowchart including steps in a method of operation of a central processing unit in a host device in the system of FIG. 1;

FIG. 3 is a flowchart including steps in a method of operation of a network device in the system of FIG. 1;

FIG. 4 is a data flow diagram illustrating an example data flow for use in the system of FIG. 1;

FIG. 5 is a flowchart including steps in a clock synchronization method for use in the system of FIG. 1;

FIG. 6 is a data flow diagram illustrating an example clock synchronization method for use in the system of FIG. 1

FIG. 7 is a block diagram view of a clock synchronization system constructed and operative in accordance with an embodiment of the present disclosure;

FIG. 8 is a dataflow diagram illustrating an example data flow for use in the system of FIG. 7;

FIG. 9 is a flowchart including steps in a first method of operation of a central processing unit in a host device in the system of FIG. 7;

FIG. 10 is a flowchart including steps in a clock synchronization method for use in the system of FIG. 7; and

FIG. 11 is a flowchart including steps in a second method of operation of the central processing unit in the host device in the system of FIG. 7.

### DESCRIPTION OF EXAMPLE EMBODIMENTS

### Overview

In PTP, the clock synchronization leader (the “leader”) sends a sync message at time T1 that is received by the clock synchronization follower (the “follower”) at time T2. The leader sends a follow up message with T1 inside the follow up message. The follower sends a delay request message at time T3, which is received by the leader at time T4. The leader in response sends a delay response message with T4 inside the delay response message. Therefore, the follower has times T1-T4 which are all the times needed to compute a time adjustment according to PTP.

The time adjustment is computed based on the difference between T1 and T4, and the difference between T2 and T3, to reduce the effect of the clocks not being synchronized. The round-trip time may be computed based on [(T4−T1)−(T3−T2)] divided by 2. However, as the clocks of the two devices may be running at different frequencies, an error is incorporated into the difference between T2 and T3.

The devices can theoretically run with different frequencies relative to each other since they are usually being fed by different oscillators. For example, in case each device is fed by its own local oscillator with a frequency stability of 50 parts per million (PPM) versus a nominal value, both oscillators can drift up to 100 PPM one from another, which means that every second can result in a drift of up to 100 microseconds. It basically means that (T4 minus T1) and (T3 minus T2) correspond to different time scales. For example, 1 second passed on device 1 will not necessarily be equal to 1 second passed on device 2, and both times will not necessarily be equal to a “real” and nominal 1 second.

The frequencies of the devices can be actively synchronized to each other, for example by running a synchronization protocol, such as Precision Time Protocol (PTP), between the nodes. Even in this case, the devices generally still rely on their local oscillators in the short term between the synchronization handshakes. Therefore, a momentary frequency jitter can occur, for example due to a temperature fluctuation near the follower device. Such jitter can result in accumulation of time error between T2 and T3, which would negatively affect the measurement. If this time (T3 minus T2) is short, for example in the nano second range, the accumulated error throughout this time will be negligible. For example, if the frequency accuracy is 100 PPM and (T3 minus T2)=10 nano seconds, the maximum time error which can be accumulated throughout this time would be equal to 1 picosecond based on 100 microseconds (i.e., the maximum drift in 1 second) divided by 100,000,000 (i.e., 10 nanoseconds relative to 1 second).

As the processing of PTP messages is performed by software running on the host, the error is not easily reduced. For example, when a sync message is received, it goes through different networking layers, e.g., from the physical layer, upper layer, etc. until it reaches the software that orchestrates PTP on the follower. Then, the delay request message needs to be sent back over a similar path through the different layers, including posting work queue entries (WQEs) etc. All the above adds significant delay to the process and increases the magnitude of the difference between T2 and T3.

Therefore, embodiments of the present disclosure address at least some of the above drawbacks by using a hardware accelerator, such as packet processing circuitry, in the network device, to identify a first time-synchronization message (e.g., PTP sync message) received from a clock leader and cause generation and sending of a second time-synchronization message (e.g., a PTP delay request message) to the clock leader in response to receiving the first time-synchronization message.

In some embodiments, the first time-synchronization message may be identified by a steering engine using match-and-action tables. The second time-synchronization message may be generated by steering (for example, using any suitable mechanism such as packet hairpin by copying the first time-synchronization message into a transmission path of the packet processing circuitry, and amending the copied packet to yield the second time-synchronization message). In some embodiments, the network device may include a data processing unit (DPU) including one or more microprocessors to generate the second time-synchronization packet.

The first time-synchronization message is transmitted by the leader at time T1, and received by the follower at time T2. The second time-synchronization message is transmitted by the follower at time T3, and received by the follower at time T4. Using the hardware accelerator to detect the first time-synchronization message and cause generation and sending of the second time-synchronization message reduces the time difference between T2 and T3 and makes the clock synchronization performed by the follower more accurate.

The leader may send one or more messages (e.g., a follow up message and a delay response message) including times T1 and T4. In some embodiments, the hardware accelerator may extract T1 and T4 from the message(s) and provide T1 and T4 (or T4 minus T1) along with T2 and T3 (or T3 minus T2) to time synchronization software running on a central processing unit of a host device connected to the network device to synchronize a hardware clock of the follower to the clock of the leader using any suitable time synchronization protocol, such as PTP. In other embodiments, the hardware accelerator may pass T2 and T3 (or T3 minus T2) to the software along with the message(s) including T1 and T4 to the time synchronization software for the software to extract T1 and T4 from the message(s). In some embodiments, the time difference between T2 and T3 is fixed, for example, by the configuration of the hardware accelerator, and therefore, the value T3 minus T2 is already known by the time synchronization software.

In some embodiments, the DPU in the network device may act as a host device running the time synchronization software.

### System Description

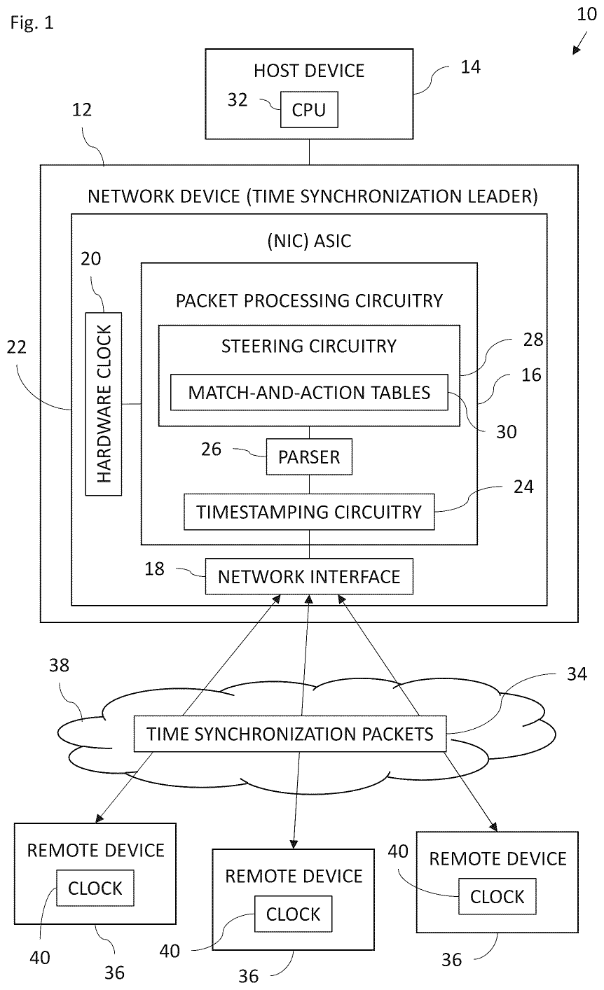

Reference is now made to FIG. 1, which is a block diagram view of a clock synchronization system 10 constructed and operative in accordance with an embodiment of the present disclosure. The clock synchronization system 10 includes a network device 12 and a host device 14 connected to the network device 12 via any suitable peripheral communication data bus operating according to any suitable protocol, for example, Peripheral Component Interconnect Express (PCIe). The host device 14 includes a central processing unit (CPU) 32.

The network device 12 includes packet processing circuitry 16, a network interface 18, and a hardware clock 20. The network device 12 may be any suitable network device such as a NIC or a network switch. The network device 12 may include an application-specific integrated circuit (ASIC) 22 such as a NIC ASIC or a switch ASIC. The packet processing circuitry 16, network interface 18 and hardware clock 20 may be implemented in the ASIC 22.

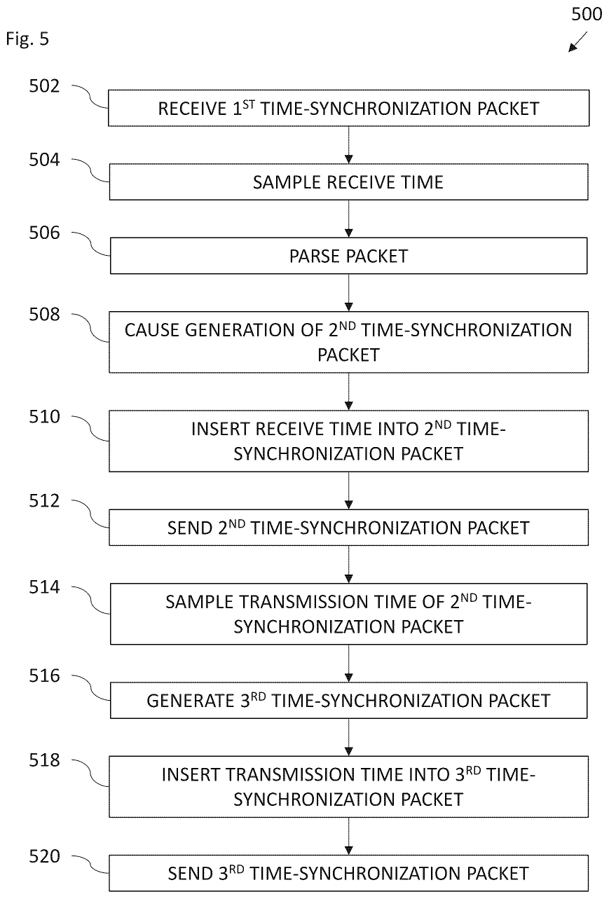

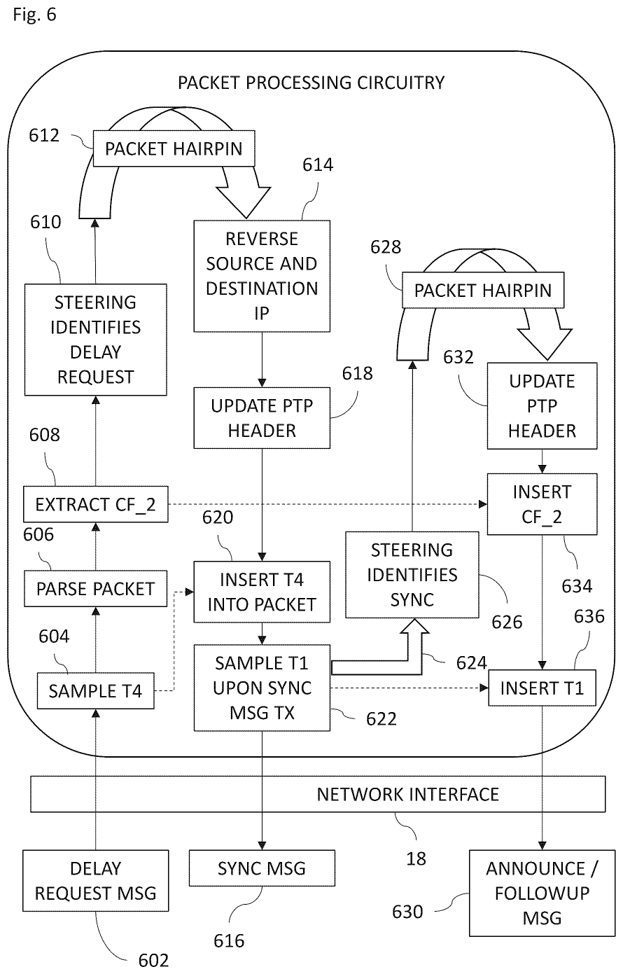

The packet processing circuitry 16 may include timestamping circuitry 24, a parser 26, and steering circuitry 28, described in more detail with reference to FIGS. 5 and 6. The steering circuitry 28 may use match and action tables 30 to determine how each packet should be processed according to the parsed information generated by the parser 26. The match and action tables 30 include data to match to the parsed information, and associated actions to be performed when a match is found. The data to be matched may include any field from the packet, for example, MAC or IP addresses, and security information, by way of example only. The actions may include any suitable action or actions per match, for example, but not limited to, forwarding a packet, copying a packet, performing a packet hairpin, inserting data into the packet, and changing data in the packet.

The hardware clock 20 is configured to maintain a clock time. The network interface 18 is configured to share time synchronization packets 34 with one or more remote devices 36 over a network 38. In some embodiments, the network device 12 is a time synchronization leader and the remote devices 36 are time synchronization followers.

The packet processing circuitry 16 is configured to process the time synchronization packets 34 according to a two-way time synchronization protocol (e.g., SPTP, Flash-PTP, PTP-Hybrid, or NTP) in order to cause clock synchronization (time and/or frequency synchronization) between the hardware clock 20 and clock(s) 40 of the remote devices 36. In some embodiments, the packet processing circuitry 16 is configured to process the time synchronization packets 34 as a time synchronization leader to synchronize the clock(s) 40 of the remote device(s) 36 to the hardware clock 20. In some embodiments, the packet processing circuitry 16 is configured to participate in multiple concurrent time synchronization processes with multiple time synchronization clients (e.g., with the remote devices 36).

In some embodiments, the packet processing circuitry 16 is configured to process the time synchronization packets 34 according to the two-way time synchronization protocol at a rate (e.g., line rate) at which the time synchronization packets 34 are received by the network interface 18. In some embodiments, the packet processing circuitry 16 is configured to process the time synchronization packets 34 according to the two-way time synchronization protocol without the time synchronization packets being processed by the CPU 32 of the host device 14 connected to the network device 12.

In some embodiments, the network device may be configured as a “smart NIC” including a data processing unit (DPU), for example, one or more microprocessors, e.g., ARM® Processors. In some embodiments, the DPU may perform part of the processing of the time synchronization packets 34 according to the two-way time synchronization protocol. In some embodiments, the DPU may behave as a host device to the ASIC 22 in which the time synchronization packets 34 are not processed by the DPU.

In some embodiments, the packet processing circuitry 16 included in the ASIC 22 is configured to perform time synchronization operations of the two-way time synchronization protocol as a clock synchronization leader or as a clock synchronization follower.

In some embodiment, all the processing tasks performed on the time synchronization packets are performed in hardware in the packet processing circuitry 16 without any software or firmware processing.

In some embodiments, at least some of the processing tasks performed on the time synchronization packets may be performed by software or firmware running on a processor in the network device. The tasks may be launched by actions identified from the match-and-action tables. However, performing tasks in software or firmware may reduce the performance speed of the time synchronization process.

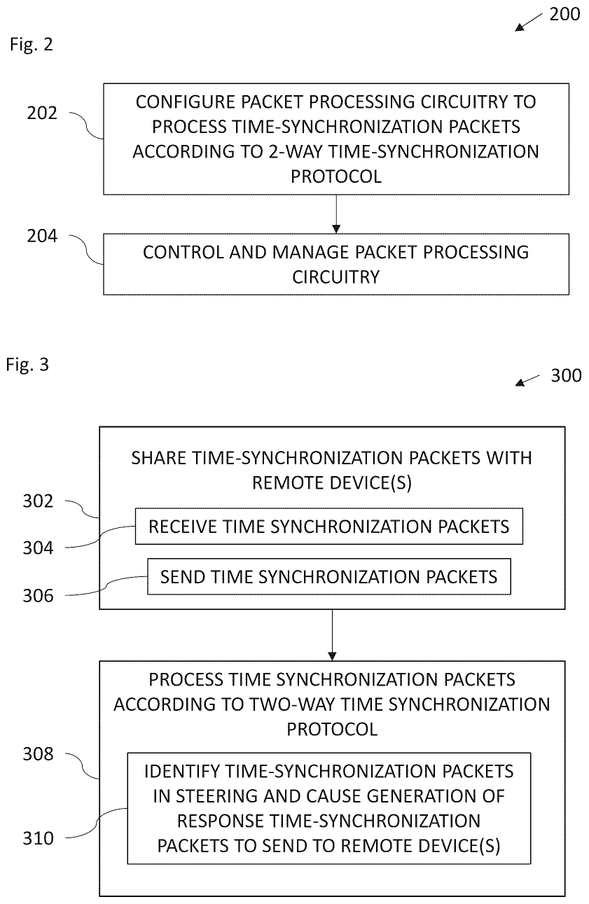

Reference is now made to FIG. 2, which is a flowchart 200 including steps in a method of operation of CPU 32 in host device 14 in the system 10 of FIG. 1. Reference is also made to FIG. 1. As previously mentioned, the packet processing circuitry 16 is configured to process the time synchronization packets 34 according to the two-way time synchronization protocol without the time synchronization packets 34 being processed by the CPU 32 of the host device 14 connected to the network device 12. However, the CPU 32 may still be managing and controlling the time synchronization process, for example, initially configuring the packet processing circuitry 16 to process the time synchronization packets 34 according to the two-way time synchronization protocol, such as setting the network address of the clock synchronization leader and configuring the relevant steering rules.

Therefore, in some embodiments, CPU 32 is configured to configure the packet processing circuitry 16 to process the time synchronization packets 34 according to the two-way time synchronization protocol (e.g., by sending a command to the packet processing circuitry 16 to commence processing time synchronization packets 34 according to the two-way time synchronization protocol and/or by configuring the match and action tables 30 so that time synchronization packets 34 received by the packet processing circuitry 16 are processed according to the two-way time synchronization protocol) and the packet processing circuitry 16 is configured to be configured by the CPU 32 to process the time synchronization packets 34 according to the two-way time synchronization protocol (block 202). The CPU 32 is configured to control and manage the packet processing circuitry 16, and the packet processing circuitry 16 is configured to be controlled and managed by the CPU 32 (block 204).

Reference is now made to FIG. 3, which is a flowchart 300 including steps in a method of operation of network device 12 in the system 10 of FIG. 1. Reference is also made to FIG. 1. The network interface 18 is configured to share time synchronization packets 34 with remote device(s) 36 over the network 38 (block 302). The network interface 18 is configured to receive time synchronization packets from the remote device(s) 36 (block 304) and send other (e.g., response) time synchronization packets to the remote device(s) 36 (block 306).

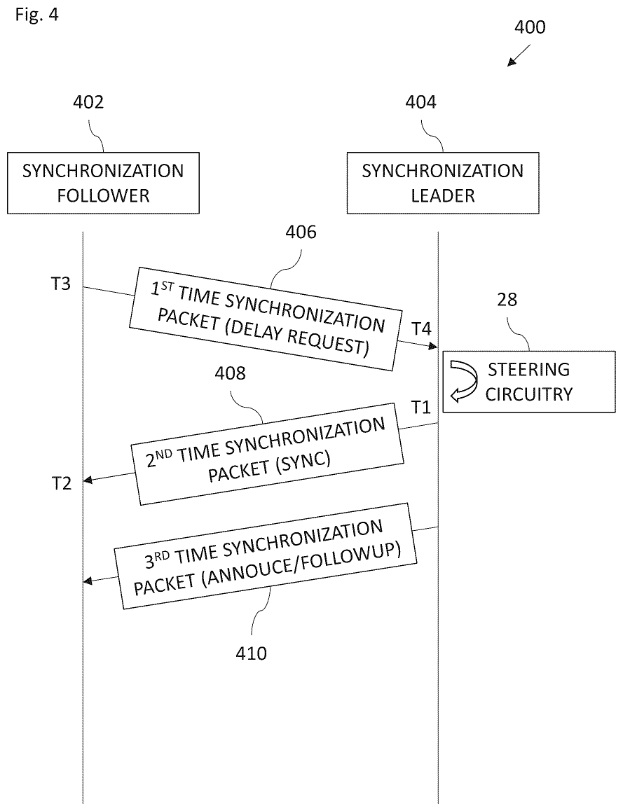

The packet processing circuitry 16 is configured to process the time synchronization packets 34 (e.g., as a time-synchronization leader) according to the two-way time synchronization protocol in order to cause clock synchronization between the hardware clock 20 and clock(s) 40 of the remote device(s) 36, e.g. to synchronize the clock(s) 36 of the remote device(s) 36 to the hardware clock 20 (block 308). The steering circuitry 28 is configured to identify received time-synchronization packets and cause generation of response time-synchronization packets to send to the remote device(s) 36 (block 310), as described in more detail with reference to FIGS. 4-6.

Reference is now made to FIG. 4, which is a data flow diagram 400 illustrating an example data flow for use in the system 10 of FIG. 1. FIG. 4 shows example packets used in a time synchronization protocol such as SPTP. Any suitable time synchronization protocol may be used according to embodiments of the present disclosure.

FIG. 4 shows a synchronization follower 402 (e.g., one of the remote devices 36) and a synchronization leader 404 (e.g., network device 12). The synchronization follower 402 sends a 1st time synchronization packet 406 (e.g., a delay request message) at time T3. The synchronization follower 402 records T3. The 1st time synchronization packet 406 is received by synchronization leader 404 at time T4, which is recorded by synchronization leader 404. The 1st time synchronization packet 406 may include a correction field (CF_2) which collects residual time of 1st time synchronization packet 406 in different switches from the synchronization follower 402 to the synchronization leader 404. The steering circuitry 28 processes the 1st time synchronization packet 406 and generates a 2nd time synchronization packet 408 (e.g., a sync message). The 2nd time synchronization packet 408 may also include a correction field (CF_1) to collect residual time of 2nd time synchronization packet 408 in different switches from synchronization leader 404 to synchronization follower 402. The steering circuitry 28 may also insert T4 into the 2nd time synchronization packet 408. The synchronization leader 404 sends 2nd time synchronization packet 408 at time T1 to synchronization follower 402. Time T1 is sampled by synchronization leader 404. The 2nd time synchronization packet 408 is received by synchronization follower 402 at time T2. The steering circuitry 28 may also generate a 3rd time synchronization packet 410 (e.g., an announce/followup message) which may include time T1, and send 3rd time synchronization packet 410 to the synchronization follower 402. Therefore, synchronization follower 402 has all the timestamps T1-T4 to be able to adjust its clock according to the two-way time synchronization protocol. More detailed steps of the above example are described now with reference to FIG. 5.

Reference is now made to FIG. 5, which is a flowchart 500 including steps in a clock synchronization method for use in the system 10 of FIG. 1. Reference is also made to FIG. 1. The flowchart 500 describes the example of FIG. 4 in more detail. Reference is also made to FIG. 4.

The interface 18 is configured to receive 1st time synchronization packet 406 from a given one of the remote devices 36 (block 502). The timestamping circuitry 24 is configured to sample a receive time (e.g., T4) of 1st time synchronization packet 406 according to the clock time of the hardware clock 20 (block 504). The parser 26 is configured to parse 1st time synchronization packet 406 yielding parsed data (block 506). The steering circuitry 28 is configured to cause generation of 2nd time synchronization packet 408 based on the parsed data (and matching the parsed data with the match and action tables 30) and 1st time synchronization packet 406 (block 508). Generation of 2nd time synchronization packet 408 may also be based on configuration data from the host device 14. For example, if the host device 14 has a Global navigation satellite system (GNSS) receiver to receive a GNSS signal, and the GNSS is down, the host device 14 may signal to the packet processing circuitry 16 that the GNSS is down so that the 2nd time synchronization packet 408 include data to notify the given remote device 36 that the GNSS receiver is down. The steering circuitry 28 is configured to insert the receive time (e.g., T4) into 2nd time synchronization packet 408 (block 510). The interface 18 is configured to send 2nd time synchronization packet 408 to the given remote device 36 (block 512). The timestamping circuitry 24 is configured to sample a transmission time (e.g., T1) of 2nd time synchronization packet 408 according to the clock time of the hardware clock (block 514). The steering circuitry 28 is configured to generate 3rd time synchronization packet 410 (block 516) and insert the transmission time (e.g., T1) into 3rd time synchronization packet 410 (block 518). The interface 18 is configured to send 3rd time synchronization packet 410 to the given remote device 36 (block 520).

Reference is now made to FIG. 6, which is a data flow diagram 600 illustrating an example clock synchronization method for use in the system 10 of FIG. 1. The following example describes processing of SPTP in the network device 12 acting as a time synchronization leader. However, the method of FIG. 6 may be suitably adapted to any suitable clock synchronization protocol.

A delay request message 602 is received by the network interface 18 and passed to packet processing circuitry 16 for further processing. The timestamping circuitry 24 samples the arrival time of the delay request message 602 (time T4) (block 604). The parser 26 parses the header of the delay request message 602 (block 606) and extracts CF_2 from the delay request message 602 (block 608). The steering circuitry 28 matches data parsed from the header of delay request message 602 with match and action tables 30 identifying the packet as a delay request message (block 610) and causing several actions. The actions include: performing a packet hairpin (block 612), which copies the delay request message 602 yielding a copied packet and places the copied packet into the transmit path of the packet processing circuitry 16; reversing the source and destination IP address in the copied packet header (block 614), updating the PTP header of the copied packet to indicate that the copied packet is a sync message 616 (block 618), and inserting the sampled timestamp (T4) into the packet (e.g., in originTimestamp field) (block 620). CF_1 may also be added to the sync message 616. The sync message 616 is then sent to the given remote device 36 over network 38 and the sync message transmission (TX) time (e.g., T1) is sampled by timestamping circuitry 24 (block 622).

The packet processing circuitry 16 duplicates the sync message 616 yielding a duplicate packet. The duplicate packet is looped back into the receive path by the packet processing circuitry 16 (block 624). The duplicate packet is parsed by parser 26, and the steering circuitry 28 matches data parsed from the header of the duplicate packet with match and action tables 30 to identify the packet as a sync message (block 626) and cause several actions. The actions include: performing a packet hairpin (block 628), which copies the duplicate packet and places the duplicate packet into the transmit path of the packet processing circuitry 16; updating the PTP header of the packet to indicate that the packet is an announce/followup packet 630 (block 632), inserting the previously parsed CF_2 data into the packet (block 634), and inserting the sampled transmission timestamp (T1) into the packet (e.g., in originTimestamp field) (block 636). The announce/followup packet 630 is then sent to the given remote device 36 over the network 38 on the same port that the sync packet 616 was sent.

In practice, some, or all of the functions of packet processing circuitry 16 may be combined in a single physical component or, alternatively, implemented using multiple physical components. These physical components may comprise hard-wired or programmable devices, or a combination of the two. In some embodiments, at least some of the functions of the packet processing circuitry 16 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

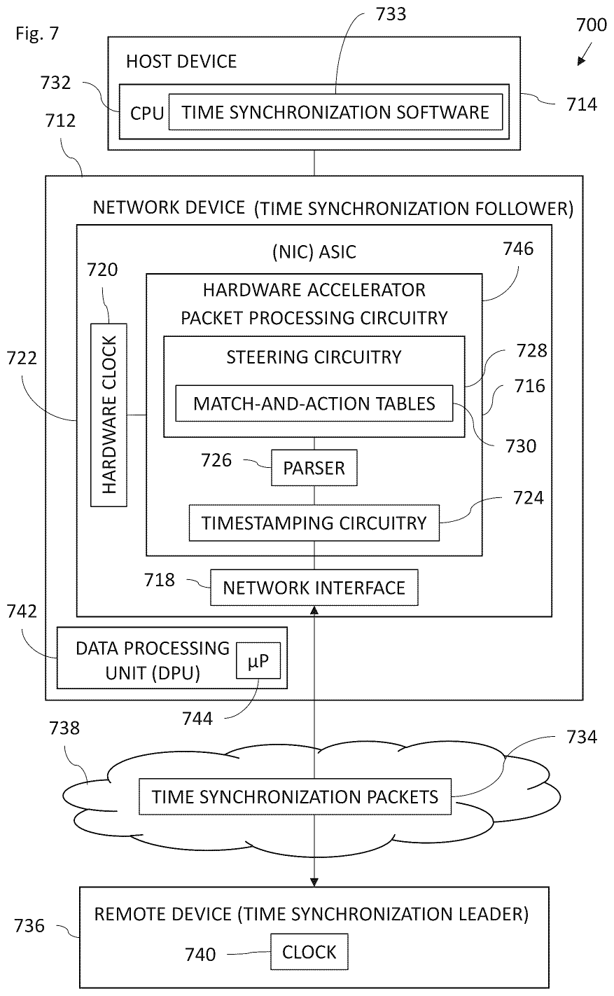

Reference is now made to FIG. 7, which is a block diagram view of a clock synchronization system 700 constructed and operative in accordance with an embodiment of the present disclosure.

The clock synchronization system 700 includes a network device 712 and a host device 714 connected to the network device 712 via any suitable peripheral communication data bus operating according to any suitable protocol, for example, Peripheral Component Interconnect Express (PCIe). The host device 714 includes a central processing unit (CPU) 732 configured to execute time-synchronization software 733.

The network device 712 includes a hardware accelerator 746. In some embodiments, the hardware accelerator 746 includes packet processing circuitry 716. The network device 712 may also include a network interface 718 and a hardware clock 720. The network device 712 may be any suitable network device such as a NIC or a network switch. The network device 712 may include an application-specific integrated circuit (ASIC) 722 such as a NIC ASIC or a switch ASIC. The packet processing circuitry 716, network interface 718 and hardware clock 720 may be implemented in the ASIC 722.

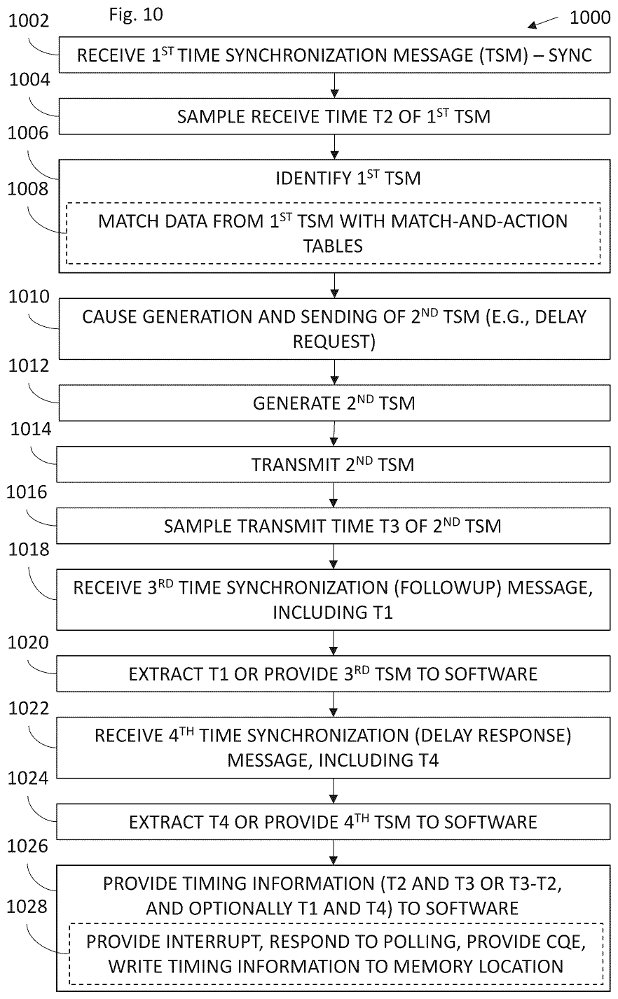

The packet processing circuitry 716 may include timestamping circuitry 724, a parser 726, and steering circuitry 728, described in more detail with reference to FIG. 10. The steering circuitry 728 may use match and action tables 730 to determine how each packet should be processed according to the parsed information generated by the parser 726. The match and action tables 730 include data to match with the parsed information, and associated actions to be performed when a match is found. The data to be matched may include any field from the packet, for example, MAC or IP addresses, and security information, by way of example only. The actions may include any suitable action or actions per match, for example, but not limited to, forwarding a packet, copying a packet, performing a packet hairpin, inserting data into the packet, and changing data in the packet.

The hardware clock 720 is configured to maintain a clock time. The network interface 718 is configured to share time synchronization packets 734 with a remote device 736 over a network 738. In some embodiments, the network device 712 is a time synchronization follower and the remote device 736 is a time synchronization leader.

The packet processing circuitry 716 is configured to process the time synchronization packets 734 according to any suitable two-way time synchronization protocol (e.g., PTP, SPTP, Flash-PTP, PTP-Hybrid, or NTP) in order to cause clock synchronization (time and/or frequency synchronization) between the hardware clock 720 and a clock 740 of the remote device 736.

In some embodiments, the packet processing circuitry 716 is configured to process the time synchronization packets 734 according to the two-way time synchronization protocol at a rate (e.g., line rate) at which the time synchronization packets 734 are received by the network interface 718. In some embodiments, the packet processing circuitry 716 is configured to process the time synchronization packets 734 according to the two-way time synchronization protocol without the time synchronization packets being processed by the CPU 732 of the host device 714 connected to the network device 712.

In some embodiments, the network device 712 may be configured as a “smart NIC” including a data processing unit (DPU) 742, which includes, for example, one or more microprocessors 744, e.g., ARM® Processors. In some embodiments, the DPU 742 may perform part of the processing of the time synchronization packets 734 according to the two-way time synchronization protocol. In some embodiments, the DPU 734 may behave as a host device to the ASIC 722 in which the microprocessors 744 execute the time-synchronization software 733.

In some embodiments, the packet processing circuitry 716 included in the ASIC 722 is configured to perform time synchronization operations of the two-way time synchronization protocol as a clock synchronization follower. In some embodiments, all the processing tasks performed on the time synchronization packets 734 are performed in hardware in the packet processing circuitry 716 without any software or firmware processing.

In some embodiments, at least some of the processing tasks performed on the time synchronization packets 734 may be performed by software or firmware running on a processor (e.g., on the DPU 742) in the network device 712. The tasks may be launched by actions identified from the match-and-action tables 730. However, performing tasks in software or firmware may reduce the performance speed of the time synchronization process.

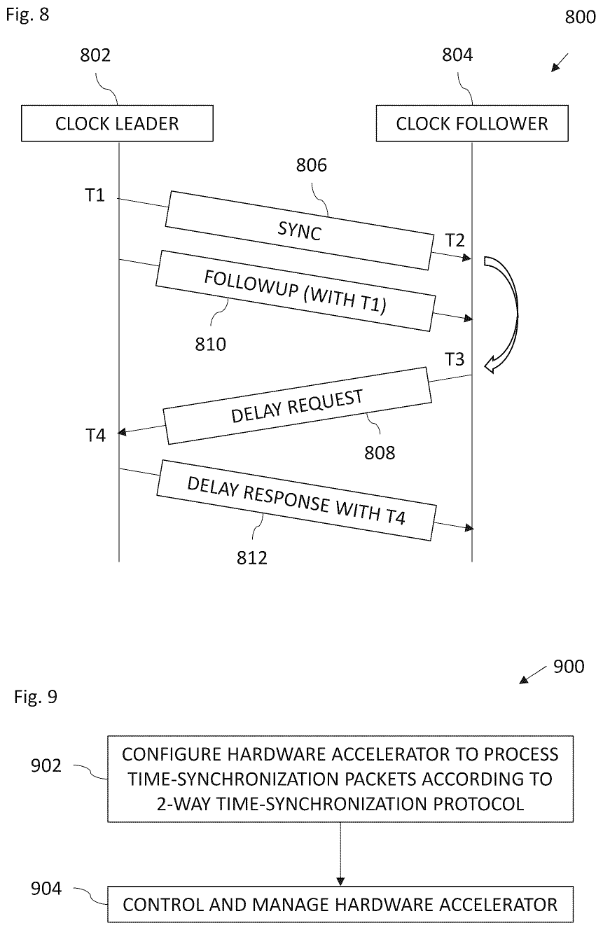

Reference is now made to FIG. 8, which is a dataflow diagram 800 illustrating an example data flow for use in the system 700 of FIG. 7. A clock leader 802 (e.g., remote device 736) sends a first time-synchronization message 806 (e.g., sync message) at time T1 to a clock follower 804 (e.g., network device 712). The first time-synchronization message 806 is received by clock follower 804 at time T2. In response to receiving first time-synchronization message 806, the clock follower 804 generates a second time-synchronization message 808 (e.g., a delay request message) and sends the second time-synchronization message 808 to the clock leader 802 at time T3. The second time-synchronization message 808 is received by clock leader 802 at time T4. The clock leader 802 also sends to clock follower 804 a third time-synchronization message 810 (e.g., a follow up message including T1) after sending first time-synchronization message 806. The clock leader 802 also sends, in response to receiving second time-synchronization message 808, a fourth time-synchronization message 812 (e.g., a delay response message including T4) to clock follower 804. The clock follower 804 may then compute a time adjustment to its clock based on times T1 to T4. In some embodiments, the two-way time synchronization protocol used in clock synchronization system 700 of FIG. 7 is Precision Time Protocol (PTP).

Reference is now made to FIG. 9, which is a flowchart 900 including steps in a first method of operation of CPU 732 in host device 714 in the system 700 of FIG. 7. Reference is also made to FIG. 7.

As previously mentioned, the packet processing circuitry 716 is configured to process at least some of the time synchronization packets 734 according to the two-way time synchronization protocol without the time synchronization packets 734 being processed by the CPU 732 of the host device 714 connected to the network device 712. However, even where CPU 732 does not process any of the time synchronization packets time synchronization packets 734, the CPU 732 may still be managing and controlling the time synchronization process, for example, initially configuring the packet processing circuitry 716 to process at least some of the time synchronization packets 734 according to the two-way time synchronization protocol, such as setting the network address of the clock synchronization follower and configuring the relevant steering rules in the match and action tables 730 as described in more detail below with reference to FIG. 10.

Therefore, in some embodiments, CPU 732 is configured to configure the hardware accelerator 746 or packet processing circuitry 716 to process the time synchronization packets 734 according to the two-way time synchronization protocol, e.g., by sending a command to the hardware accelerator 746 or packet processing circuitry 716 to commence processing time synchronization packets 734 according to the two-way time synchronization protocol and/or by configuring the match and action tables 730 so that time synchronization packets 734 received by the packet processing circuitry 716 are processed according to the two-way time synchronization protocol (block 902). The CPU 732 is configured to control and manage the hardware accelerator 746 or packet processing circuitry 716 (block 904).

Reference is now made to FIG. 10, which is a flowchart 1000 including steps in a clock synchronization method for use in system 700 of FIG. 7. Reference is also made to FIG. 7. The network interface 718 is configured to receive first time-synchronization message 806 from clock leader 802 as part of a two-way time synchronization protocol (block 1002).

One or more of the steps described below as being performed by the packet processing circuitry 716, may, in some embodiments, be performed by any suitable hardware accelerator, such as hardware accelerator 746.

The packet processing circuitry 716 is configured to sample a receive time T2 of first time-synchronization message 806 (block 1004). The packet processing circuitry 716 is configured to identify first time-synchronization message 806 (block 1006) and cause generation and sending of second time-synchronization message 808 to clock leader 802 in response to identifying first time-synchronization message 806 (block 1010).

In some embodiments, the steering circuitry 728 is configured to identify first time-synchronization message 806 (after the header of first time-synchronization message 806 is parsed by the parser 726) and cause generation and sending of second time-synchronization message 808 based on matching data from the (header of) first time-synchronization message 806 with match-and-action tables 730 (block 1008). In some embodiments, the steering circuitry 728 is configured to generate second time-synchronization message 808 (block 1012) for example, using any suitable mechanism such as packet hairpin by copying the first time-synchronization message 806 into a transmission path of the packet processing circuitry 716, and amending the copied packet to yield the second time-synchronization message 808. In other embodiments, the DPU 742 is configured to generate second time-synchronization packet 808.

The packet processing circuitry 716 is configured to transmit second time-synchronization message 808 to clock leader 802 (block 1014). The packet processing circuitry 716 is configured to sample a transmission time T3 of second time-synchronization message 808 (block 1016).

The network interface 718 is configured to receive from clock leader 802 third time-synchronization message 810 including the transmission time T1 of the first time-synchronization message 806 (block 1018). The packet processing circuitry 716 is configured to: (a) extract the transmission time T1 of first time-synchronization message 806 from third time-synchronization message 810 and provide the extracted transmission time T1 to time-synchronization software 733 (as described in more detail with reference to the step of block 1026); or (b) provide third time-synchronization message 810 to time-synchronization software 733 running on the host device 714 to extract T1 and synchronize the hardware clock 720 to the clock synchronization leader 802 based on the transmission time T1 of first time-synchronization message 806 in third time-synchronization message 810 (and other time values, described in more detail below with reference to the step of block 1026) (block 1020).

The network interface 718 is to receive fourth time-synchronization message 812 including receive time T4 of second time-synchronization message 808 (block 1022). The packet processing circuitry 716 is configured to: (a) extract receive time T4 of second time-synchronization message 808 from fourth time-synchronization message 812 and provide the extracted receive time T4 to the time-synchronization software 733 (as described in more detail with reference to the step of block 1026); or (b) provide fourth time-synchronization message 812 to time-synchronization software 733 to extract T4 and synchronize the hardware clock 720 to the clock synchronization leader 802 based on the receive time of second time-synchronization message 808 included in fourth time-synchronization message 812 (and other time values, described in more detail below with reference to the step of block 1026) (block 1024).

The packet processing circuitry 716 is configured to provide timing information associated with first time-synchronization message 806 and second time-synchronization message 808 to time-synchronization software 733 running on host device 714 to synchronize the hardware clock 720 to the clock synchronization leader (block 1026). The timing information may be indicative of the receive time T2 (and optionally the transmission time T1) of first time-synchronization message 806 and the transmission time T3 (and optionally the receive time T4) of second time-synchronization message 808. The step of block 1026 may include packet processing circuitry 716 being configured to provide the sampled receive time T2 and the sampled transmission time T3, or a difference between the sampled transmission time T3 and the sampled received time T2, or another time value based on the sampled receive time T2 and the sampled transmission time T3 to the time-synchronization software 733. In some embodiments, the difference between T2 and T3 is a predefined fixed time-difference predefined by the configuration of the hardware accelerator 746 or packet processing circuitry 716, and therefore, the value T3 minus T2 is already known by the time synchronization software 733. The step of block 1026 may include the packet processing circuitry 716 being configured to provide the extracted transmission time T1 and the extracted receive time T4 (extracted in the steps of blocks 1020 and 1024), or a difference between the extracted transmission time T1 and the extracted receive time T4, or another time value based on the extracted transmission time T1 and the extracted receive time T4, to the time-synchronization software 733 running on the host device 714.

In some embodiments, the packet processing circuitry 716 is configured to provide the timing information to time-synchronization software 733 by any suitable method including any one or more of the following: providing an interrupt to the time-synchronization software 733; responding to polling of time-synchronization software 733; generating a completion queue entry including the timing information or including a link to the timing information; and writing the timing information in at least one memory location for detection by the time-synchronization software 733 (block 1028).

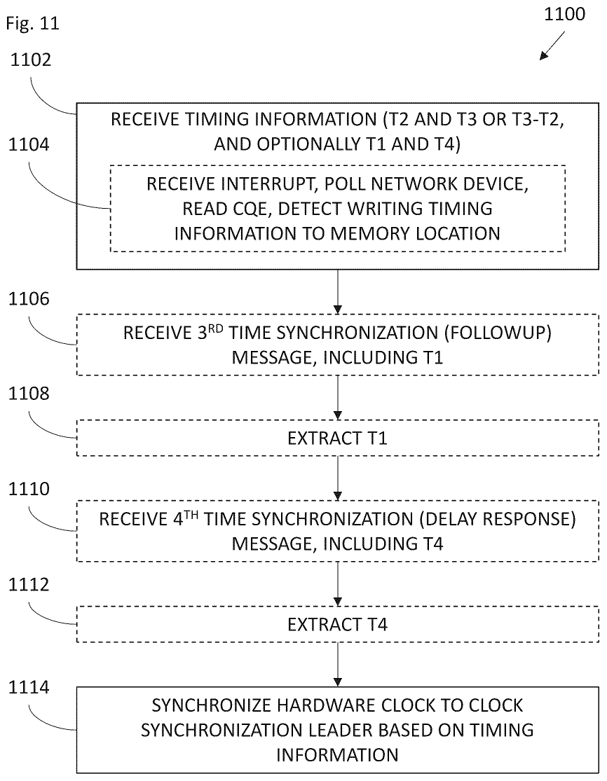

Reference is now made to FIG. 11, which is a flowchart 1100 including steps in a second method of operation of CPU 732 in the host device 714 in the system 700 of FIG. 7. Reference is also made to FIG. 7. The time-synchronization software 733 is configured to receive the timing information provided by the packet processing circuitry 716 (block 1102). In some embodiments, the time-synchronization software 733 is configured to receive the timing information in response to any one or more of the following: receiving an interrupt from the network device 712; polling the network device 712; a completion queue entry; and detecting writing of the timing information in at least one memory location (block 1104). In some embodiments, the time-synchronization software 733 is configured to receive the third time-synchronization message 810 (block 1106) and extract time T1 from third time-synchronization message 810 (block 1108). In some embodiments, the time-synchronization software 733 is configured to receive fourth time-synchronization message 812 (block 1110) and extract time T4 from fourth time-synchronization message 812 (block 1112). The time-synchronization software 733 is configured to synchronize the hardware clock 720 to the clock 740 of the clock synchronization leader 802 based on the timing information (block 1114). In some embodiments, the DPU 742 is to act as the host device to execute the time-synchronization software 733 to receive the timing information, and synchronize the hardware clock 720 to the clock synchronization leader 802 based on the timing information.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A system, comprising:
a hardware clock to maintain a clock time; and
a network device including:
a network interface to receive a first time-synchronization message from a clock synchronization leader as part of a two-way time synchronization protocol; and
a hardware accelerator to: identify the first time-synchronization message; cause generation and sending of a second time-synchronization message to the clock synchronization leader in response to identifying the first time synchronization message; and provide timing information associated with the first time-synchronization message and the second time-synchronization message to time-synchronization software running on a host device to synchronize the hardware clock to the clock synchronization leader.

2. The system according to claim 1, further comprising a host device to execute the time-synchronization software to:
receive the timing information; and
synchronize the hardware clock to the clock synchronization leader based on the timing information.

3. The system according to claim 2, wherein the timing information is indicative of a transmission and receive time of the first time-synchronization message and a transmission and receive time of the second time-synchronization message.

4. The system according to claim 2, wherein the time-synchronization software is to receive the timing information in response to any one or more of the following:
receiving an interrupt from the network device;
polling the network device;
a completion queue entry; and
detecting writing of the timing information in at least one memory location.

5. The system according to claim 1, wherein the network device includes a data processing unit (DPU) including one or more microprocessors, the DPU is to act as the host device to execute the time-synchronization software to:
receive the timing information; and
synchronize the hardware clock to the clock synchronization leader based on the timing information.

6. The system according to claim 1, wherein the hardware accelerator includes packet processing circuitry to:
identify the first time-synchronization message;
cause generation and sending of the second time-synchronization message to the clock synchronization leader in response to identifying the first time-synchronization message; and
provide timing information associated with the first time-synchronization message and the second time-synchronization message to the time-synchronization software running on the host device to synchronize the hardware clock to the clock synchronization leader.

7. The system according to claim 6, wherein the packet processing circuitry includes steering circuitry to identify the first time-synchronization message and cause generation and sending of the second time-synchronization message based on matching data from the first time-synchronization message with match-and-action tables.

8. The system according to claim 7, wherein the steering circuitry is to generate the second time-synchronization packet.

9. The system according to claim 7, wherein the network device includes a data processing unit (DPU) including one or more microprocessors, the DPU is to generate the second time-synchronization packet.

10. The system according to claim 6, wherein the packet processing circuitry is to:
sample a receive time of the first time-synchronization message and a transmission time of the second time-synchronization message; and
provide the sampled receive time and the sampled transmission time or a difference between the sampled transmission time and the sampled received time or another time value based on the sampled receive time and the sampled transmission time to the time-synchronization software running on the host device.

11. The system according to claim 10, wherein:
the network interface is to receive a third time-synchronization message including the transmission time of the first time-synchronization message; and
the network interface is to receive a fourth time-synchronization message including the receive time of the second time-synchronization message.

12. The system according to claim 11, wherein the packet processing circuitry is to:
extract the transmission time of the first time-synchronization message and the receive time of the second time-synchronization message from the third time synchronization message and the fourth time-synchronization message, respectively; and
provide the extracted transmission time and the extracted receive time or a difference between the extracted transmission time and the extracted receive time or another time value based on the extracted transmission time and the extracted receive time to the time-synchronization software running on the host device.

13. The system according to claim 11, wherein the packet processing circuitry is configured to provide the third time-synchronization message and the fourth time-synchronization message to the time-synchronization software running on the host device to synchronize the hardware clock to the clock synchronization leader based on the transmission time of the first time-synchronization message and the receive time of the second time-synchronization message included in the third time synchronization message and the fourth time-synchronization message, respectively.

14. The system according to claim 1, wherein a difference between: (a) a receive time of the first time-synchronization message; and (b) a transmission time of the second time-synchronization message, is a predefined fixed time-difference predefined by a configuration of the hardware accelerator.

15. The system according to claim 1, wherein:
the two-way time synchronization protocol is Precision Time Protocol (PTP);
the first-time synchronization message is a sync message; and
the second-time synchronization message is a delay request message.

16. A method, comprising:
maintaining a clock time;
receiving a first time-synchronization message from a clock synchronization leader as part of a two-way time synchronization protocol;
identifying by a hardware accelerator the first time-synchronization message;
causing by the hardware accelerator generation and sending of a second time-synchronization message to the clock synchronization leader in response to identifying the first time-synchronization message; and
providing by the hardware accelerator timing information associated with the first time-synchronization message and the second time-synchronization message to time-synchronization software running on a host device to synchronize a hardware clock to the clock synchronization leader.

17. The method according to claim 16, further comprising:
receiving by the software the timing information; and
synchronizing by the software the hardware clock to the clock synchronization leader based on the timing information.

18. The method according to claim 17, wherein the timing information is indicative of a transmission and receive time of the first time-synchronization message and a transmission and receive time of the second time-synchronization message.

19. The method according to claim 16, wherein a difference between: (a) a receive time of the first time-synchronization message; and (b) a transmission time of the second time-synchronization message, is a predefined fixed time-difference predefined by a configuration of the hardware accelerator.

20. The method according to claim 16, wherein:
the two-way time synchronization protocol is Precision Time Protocol (PTP);
the first-time synchronization message is a sync message; and
the second-time synchronization message is a delay request message.
